(19) United States
(12) Patent Application Publication
(10) Pub. No.: US 2025/0363554 A1
(43) Pub. Date: Nov. 27, 2025

(54) METHOD AND SYSTEM FOR ENABLING PEER-TO-PEER (P2P) TRANSACTIONS OF ENERGY ASSETS IN AN ENERGY CONTROL PLATFORM

(71) Applicant: Patepojat Oy, Mäntsälä (FI)

(72) Inventors: Antti Kokkinen, Espoo (FI); Aarne Ylä-Rotiala, Mäntsälä (FI); Harri Okkonen, Heinola (FI)

(21) Appl. No.: 18/675,010

(22) Filed: May 27, 2024

Related U.S. Application Data
(60) Provisional application No. 63/469,050, filed on May 26, 2023.

(51) Int. Cl. G06Q 40/04; G06Q 50/06

(52) U.S. Cl. CPC G06Q 40/04; G06Q 50/06

(57) ABSTRACT

An energy control platform enabling P2P sharing of energy assets among a plurality of participants. Each participant is associated with an asset vault of a plurality of asset vaults, that is connected to a dedicated asset manager of a plurality of asset managers. A control unit analyzes a plurality of parameters such as, timing information, energy-type, and location of energy associated with the plurality of asset managers and categorizes the plurality of asset managers into a plurality of asset manager pools. The control unit computes an aggregate of production and consumption proposal corresponding to each asset manager pool and computes one or more bids for each asset manager pool. An exchange unit receives the one or more bids and identifies one or more other asset manager pools matching the aggregate production and consumption proposal. The exchange unit places bids and completes one or more transactions.

### CROSS-REFERENCE TO PRIOR APPLICATION

This application claims the benefit of and priority to U.S. Provisional Patent Application Ser. No. 63/469,0540, filed on May 26, 2023, which is hereby incorporated herein by reference in its entirety.

### FIELD

Various embodiments of the present disclosure generally relate to an energy control platform. More particularly, the disclosure relates to a method and system for enabling Peer-to-Peer (P2P) transactions of energy assets among a plurality of participants in an energy control platform, wherein the plurality of participants can be energy producers and energy consumers situated at different geographical locations.

### BACKGROUND

Existing energy control platforms are usually managed by large market players such as corporations producing electricity in large power plants and network companies, distributing it to big customers and thousands of mid-size and small customers. However, this structure presents significant barriers to entry for small industries and individual users, leading to friction within the energy trading ecosystem. These traditional platforms, which are largely designed to cater to the needs of major market players, often lack the flexibility to accommodate microtransactions, hindering the participation of individual users with specific energy needs.

Small electricity users and providers are typically excluded from participating in demand and supply mechanisms that influence energy prices, further exacerbating the disparity in access and contributing to market inefficiencies. Moreover, existing platforms struggle to effectively balance essential factors such as energy supply and demand in real-time, leading to delayed responses to actual requirements and potentially resulting in high prices or, in extreme cases, brownouts or blackouts.

The evolving landscape of energy generation, characterized by a shift towards renewable energy sources such as wind, solar, and water (green energy), adds complexity to the energy marketplace. This transition introduces unpredictability and efficiency challenges that traditional platforms are ill-equipped to address, further highlighting the need for innovative solutions.

In current mechanisms, the matching of electricity supply and demand happens at the electric grid and is primarily driven by non-real-time pricing, with static pricing dynamics. However, this approach lacks the flexibility to set prices in real-time and for future instances as well, hindering efficient resource allocation and responsiveness to market fluctuations.

Additionally, the management of physical battery storage and discharging timing relies heavily on hourly market prices, with the pricing of energy saving closely mirroring consumption rates. However, during critical periods such as brownouts or blackouts, the value of saved kilowatt-hours can significantly exceed standard consumption rates, underscoring the inadequacy of existing mechanisms.

Further, the efforts to lower electricity demand typically involve either contractual price adjustments, which are slow to implement, or the implementation of lower tariffs in exchange for reduced electricity usage, a process that often fails to address urgent supply shortages in a timely manner.

As the number of active participants in the energy marketplace continues to grow, the challenges of satisfying supply and demand match becomes increasingly pronounced. Existing network providers lack intelligent and sufficiently fast methods to reduce demand in microgrids or localized consumption areas during abnormal situations such as brownouts or blackouts.

Therefore, there is a significant need for a method and system that can enable P2P transactions of energy assets among a plurality of participants situated at distinct geographical locations, with distinct energy consumption requirements and energy production offers.

### SUMMARY

The present disclosure provides an energy control platform that enables P2P sharing of energy assets among a plurality of participants of the energy control platform. Each participant of the plurality of participants is associated with an asset vault of a plurality of asset vaults that are connected to an energy grid. Each asset vault of the plurality of asset vaults is configured to consume energy, produce energy, and store energy. Each asset vault is connected to a dedicated asset manager of a plurality of asset managers that are connected via an overlay communication network.

A control unit of the plurality of the control units connected to the plurality of asset managers via one or more communication interfaces, is configured to analyze a plurality of parameters such as, timing information of energy requirement or availability, energy-type requirement of availability, and location of energy requirement or availability that are associated with the plurality of asset managers. The control unit, by utilizing one or more clustering algorithms, categorizes the plurality of asset managers into a plurality of asset manager pools based on the plurality of parameters. The control unit then computes an aggregate of production proposal and consumption proposal corresponding to each asset manager pool, and then computes one or more bids for each asset manager pool.

An exchange unit, connected via the communication fabric, receives the computed one or more bids corresponding to the plurality of asset managers and identifies one or more other asset manager pools matching the aggregate production and consumption proposal based on the parameters. The exchange unit places bids for the aggregate production and consumption proposal and completes one or more transactions upon acceptance of the bids by the one or more asset manager pools.

The exchange unit, upon determining that there are leftover bids, works with one or more exchanges of the energy grids to see if the requirements can be matched. This process involves generating revised bids and attempting to find a suitable match within the energy grids.

These and other features and advantages of the present disclosure may be appreciated from a review of the following detailed description of the present disclosure, along with the accompanying figures in which like reference numerals refer to like parts throughout.

### BRIEF DESCRIPTION OF THE FIGURES

The accompanying figures where like reference numerals refer to identical or functionally similar elements throughout the separate views and which together with the detailed description below are incorporated in and form part of the specification, serve to further illustrate various embodiments and to explain various principles and advantages all in accordance with the disclosure.

FIG. 1 is a diagram that illustrates an exemplary environment 100 within which various embodiments of the present disclosure may function.

FIG. 2 is a diagram that illustrates the energy control platform 108 enabling P2P transactions of energy assets among a plurality of participants, in accordance with an embodiment of the disclosure.

FIG. 3 is a diagram that illustrates a flow chart 300 for a method for enabling P2P transactions of energy assets among a plurality of participants of an energy control platform, in accordance with an embodiment of the disclosure.

### DETAILED DESCRIPTION

The following described limitations may be found in a method and system for enabling Peer-to-Peer (P2P) transactions of energy assets among a plurality of participants in an energy control platform as described herein.

Before describing in detail embodiments that are in accordance with the present disclosure, it should be observed that the embodiments reside primarily in combinations of components related to a method and system for enabling P2P transactions of energy assets among a plurality of participants in an energy control platform.

Various embodiments of the present disclosure provide an energy control platform that enables P2P sharing of energy assets among a plurality of participants of the energy control platform. Each participant of the plurality of participants is associated with an asset vault of a plurality of asset vaults that are connected to an energy grid of a plurality of energy grids. Each asset vault of the plurality of asset vaults is configured to consume energy, produce energy, and store energy. Each asset vault of the plurality of asset vaults is connected to a dedicated asset manager of a plurality of asset managers that are connected via an overlay communication network. A control unit of the plurality of the control units is connected to the asset managers via one or more communication interfaces, is configured to analyze a plurality of parameters such as, timing information of energy requirement or availability, energy-type requirement of availability, and location of energy requirement or availability that are associated with the plurality of asset managers. The control unit, by utilizing one or more clustering algorithms, categorizes the plurality of asset managers into a plurality of asset manager pools based on the plurality of parameters. The control unit then computes an aggregate of production proposal and consumption proposal corresponding to each asset manager pool, and then computes one or more bids for each asset manager pool. An exchange unit, connected via the communication fabric, receives the computed one or more bids corresponding to the plurality of asset managers and identifies one or more other asset manager pools matching the aggregate production and consumption proposal based on the parameters. The exchange unit places bids for the aggregate production and consumption proposal and completes one or more transactions upon acceptance of the bids by the one or more asset manager pools.

The exchange unit, upon determining that there are leftover bids, works with exchanges of the energy grids to see if the requirements can be matched. This process involves generating revised bids and attempting to find a suitable match within the energy grids.

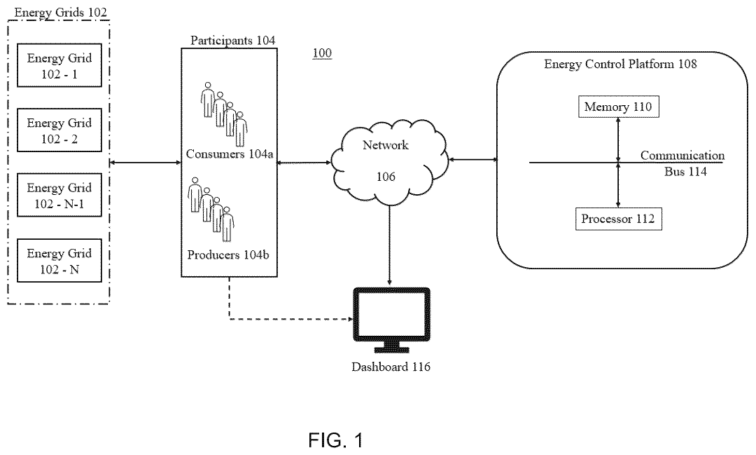

FIG. 1 is a diagram that illustrates an exemplary environment 100 within which various embodiments of the present disclosure may function. Referring to FIG. 1, the environment 100 comprises a plurality of energy grids 102, a plurality of participants 104, a network 106, an energy control platform 108, and a dashboard 116. The energy control platform 108 further comprises a memory 110, a processor 112, and a communication bus 114.

Each energy grid (102-1, 102-2, 102-N−1 . . . 102-N) of the plurality of energy grids 102 is a complex network of interconnected power generation, transmission, and distribution infrastructure that delivers electricity from power plants to the plurality of participants 104. In some non-limiting embodiments, various sources of energy generation by the plurality of energy grids 102 can be such as, fossil fuels (coal, natural gas), nuclear power, renewable energy (solar, wind, hydroelectric), even cogeneration systems that harness waste heat.

Each energy grid (102-1, 102-2, 102-N−1 . . . 102-N) of the plurality of energy grids 102 comprises an exchange that serves as a hub or interface, enabling seamless communication between the energy grid and various entities such as power plants, substations, renewable energy sources, smart meters, and other infrastructure components. Through this communication capability, each energy grid (102-1, 102-2, 102-N−1 . . . 102-N) can efficiently coordinate and manage the flow of electricity, exchange data for monitoring and control purposes, and respond dynamically to changes in demand or supply conditions.

The plurality of participants 104 in the environment 100 can be energy consumers 104a with energy consumption requirements and energy producers 104b with energy production offers. The energy consumers 104a and the energy producers 104b of the plurality of participants 104, can be from the same geographical location or different geographical locations.

The energy consumers 104a with energy consumption requirements rely on external sources to fulfill their energy needs. They may include residential, commercial, or industrial consumers who consume electricity, heat, or other forms of energy for various purposes. Energy consumers 104a specify their consumption requirements including the quantity, timing information, and quality of energy needed to support their operations and activities.

The energy producers 104b have energy production offers and are capable of generating or supplying energy to the grid or other participants in the energy control platform 108. They may include power plants, renewable energy facilities and distributed energy resources. Energy producers 104b specify their production offers, including the quantity, type, and availability of energy they can supply to the market. They may generate energy from various sources such as fossil fuels, renewable sources, or alternative technologies.

The network 106 includes communication networks operable to facilitate communication, either wirelessly or wired. Any of the communications networks may include, but are not limited to, any one of a combination of different types of suitable communications networks such as, for example, cable networks, public networks (for example, the Internet), private networks, wireless networks, cellular networks, or any other suitable private and/or public networks. Further, any of the communication networks may have any suitable communication range associated therewith and may include, for example, global networks (for example, the Internet), metropolitan area networks (MANs), wide area networks (WANs), local area networks (LANs), or personal area networks (PANs). In addition, any of the communications networks may include any type of medium over which network traffic may be carried including, but not limited to, coaxial cable, twisted-pair wire, optical fiber, a hybrid fiber coaxial (HFC) medium, microwave terrestrial transceivers, radio frequency communication mediums, white space communication mediums, ultra-high frequency communication mediums, satellite communication mediums, or any combination thereof.

The plurality of participants 104 access the energy control platform 108 via the network 106. The plurality of participants 104 initially register themselves with the energy control platform 108, typically through the dashboard 116 of a web portal or a mobile application, to store and access the energy information in the energy control platform 108. The plurality of participants 104 provide required profile information along with energy consumption or production profile, and any other relevant information requested by the energy control platform 108. Registered participants with unique login credentials, can login to the energy control platform 108 to access energy information and perform energy transactions tailored to their roles and permissions.

The energy control platform 108 enables P2P transactions of energy assets among the plurality of participants 104. The energy control platform 108 serves as a digital energy marketplace where the plurality of participants 104 can interact with each other to buy, sell, or exchange energy assets directly, without the involvement of intermediaries such as utility companies or energy suppliers.

The energy control platform 108 employs one or more advanced machine learning algorithms and matching technologies to facilitate the matching of supply and demand for energy assets among participants. It analyzes factors such as location, quantity, timing information, pricing, and user preferences to identify compatible trading opportunities. Once a potential match is identified by the energy control platform 108, each participant of the plurality of participants 104 can engage in negotiations and communication to finalize the terms of energy transactions. This may involve discussions on pricing, delivery schedules, quality standards, and other relevant terms or conditions.

The memory 110 may comprise suitable logic, circuitry, interfaces, and/or code, that may be configured to store instructions (for example, computer-readable program code) that can implement various aspects of the present disclosure.

The processor 112 may comprise suitable logic, circuitry, interfaces, and/or code, that may be configured to execute the instructions stored in the memory 110 to implement various functionalities of the energy control platform 108 in accordance with various aspects of the present disclosure. The processor 112 may be further configured to communicate with various components of the energy control platform 108 via the communication bus 114.

The communication bus 114 is configured to serve the energy control platform 108, facilitating seamless communication, integration, and coordination among its constituent components. Through its role as a centralized message broker, the communication bus 114 enables P2P transactions of energy assets among the plurality of participants 104 in the energy control platform 108.

The dashboard 116 is accessible to the plurality of participants 104 to access and view the energy information that is stored in the energy control platform 108. The dashboard 116 allows the plurality of participants 104 to access summarized and visualized energy information through a user-friendly user interface. The dashboard 116 can be a web-based or a software-based interface designed to present the energy information in a clear, concise, and interactive format.

In some non-limiting embodiments, the dashboard 116 is accessible to the plurality of participants 104 through secure login credentials or authentication mechanisms to protect sensitive energy information and ensure privacy. The dashboard 116 may include multiple tabs, panels or widgets that display various metrics, charts, graphs, or tables related to energy consumption, production, costs, or performance. The dashboard 116 may offer customization options that allow the plurality of participants 104 to tailor the displayed information to their specific preferences or interests.

In operation, the energy control platform 108 enables P2P sharing of energy assets among the plurality of participants 104, that are situated at distinct geographical locations. Energy consumers 104a and energy producers 104b of the plurality of participants 104 may comprise corresponding asset vaults that are in turn connected to the plurality of energy grids 102. The energy control platform 108 serves as a digital energy marketplace where the plurality of participants 104 can interact with each other to buy, sell, or exchange energy assets directly. The energy control platform 108 employs one or more advanced machine learning algorithms and matching technologies to facilitate the matching of supply and demand for energy assets among the plurality of participants 104. The energy control platform 108 analyzes factors such as location, quantity, timing information, pricing, and user preferences to identify compatible trading opportunities. Once a potential match is identified by the energy control platform 108, each participant of the plurality of participants 104 can engage in negotiations and communication to finalize the terms of energy transactions, which may include discussions on pricing, delivery schedules, quality standards, and other relevant terms or conditions. The energy control platform 108 transfers energy information to the dashboard 116, via the network 106. The energy control platform 108 further allows the plurality of participants 104 to access the dashboard 116 to view summarized and visualized energy information.

Computer readable program instructions are typically loaded onto the energy control platform 108 to cause a series of operations to be performed by the processor 112 of the energy control platform 108 and thereby effect the method, specified in flowcharts and/or narrative descriptions of computer-implemented methods included in the document (collectively referred to as “the inventive methods”). These computer readable program instructions are stored in various types of computer readable storage media, such as cache, for example. The program instructions, and associated data, are accessed by, and executed by, the processor 112 to control and direct performance of the inventive methods.

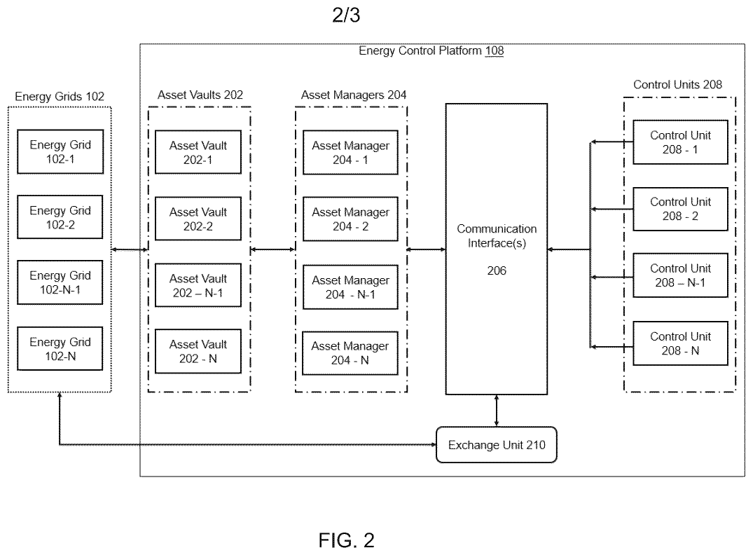

FIG. 2 is a diagram that illustrates the energy control platform 108 enabling P2P transactions of energy assets among the plurality of participants 104 in accordance with an embodiment of the disclosure. Referring to FIG. 2, the energy control platform 108 comprises a plurality of asset vaults 202, a plurality of asset managers 204, one or more communication interfaces 206, a plurality of control units 208, and an exchange unit 210.

The plurality of asset vaults 202 may comprise suitable logic, and/or interfaces, are connected to the plurality of energy grids 102. Each asset vault (202-1, 202-2, 202-N−1 . . . 202-N) of the plurality of asset vaults 202 is configured to consume energy, produce energy, and store energy. As a consumer of energy, each vault is equipped with various systems and machinery essential for its operation. These systems might include climate control mechanisms to maintain optimal environmental conditions for stored assets, security systems, and computational infrastructure for data management and analysis. Producing energy involves the implementation of renewable energy generation technologies such as, wind-based energy production, a solar-based energy production, hydro-based energy production, nuclear based energy production, and a coal-based energy production, or even cogeneration systems that harness waste heat. Each asset vault (202-1, 202-2, 202-N−1 . . . 202-N) of the plurality of asset vaults 202 is endowed with energy storage capabilities, allowing it to store excess energy produced during periods of low demand or abundant renewable energy generation. This stored energy can then be tapped into during peak demand times or when renewable energy sources are insufficient, ensuring a consistent and reliable power supply for the vault's operations.

Each asset vault (202-1, 202-2, 202-N−1 . . . 202-N) regulates energy consumption by controlling the operation of various equipment and systems, such as HVAC (Heating, Ventilation, and Air Conditioning) systems, lighting, security systems, and other energy-consuming devices. It may adjust settings, schedules, or operating modes to optimize energy usage while maintaining operational requirements.

Each asset vault (202-1, 202-2, 202-N−1 . . . 202-N) of the plurality of asset vaults 202 is managed by a dedicated asset manager of the plurality of asset managers 204. For instance, the asset vault 202-1 is managed and controlled by its corresponding asset manager 204-1. The asset manager 204-1 is responsible for the management and supervision of its assigned asset vault 202-1.

In an embodiment, the asset vault 202-1 of the plurality of asset vaults 202 share information obtained from an associated participant to it's the asset manager 204-1 of the plurality of asset managers 204. Information obtained from the associated participant can be the plurality of parameters such as, timing information of energy consumption of availability, energy-type consumption or availability, and location of energy consumption or availability.

Timing information of energy consumption or availability associated with an asset vault can be a specific time or time frame during which the energy is needed by the participant. It could include requirements for energy on an hourly, daily, weekly, monthly, seasonal, or even annual basis. In addition, the timing information of energy requirement or availability comprises real-time consumption requirements and production offers, and future consumption requirements and production offers. Real-time consumption requirements can be an immediate or current need of energy by the participant. Real-time production offer, on other hand, involves the ability of the participant to generate or supply energy to the grid or other participants at the current moment. Future consumption requirement is anticipated or forecasted energy needs of the participant over a specified period in the future. This can include projections of energy usage for hours, days, weeks, or even longer timeframes based on historical data, weather forecasts, operational schedules, or other factors. Future production offer entails the planned or expected generation or supply of energy by the participant at some point in the future. This can involve scheduling the operation of renewable energy facilities, maintenance activities, or strategic decisions regarding energy production and delivery.

Energy-type consumption or availability associated with an asset vault can be a type of form of energy needed by the participant to fulfill their requirements. For instance, the energy-type of energy requirement or availability comprises fossil fuels (coal, natural gas), nuclear power, renewable energy (solar, wind, hydroelectric), even cogeneration systems that harness waste heat.

Location of energy consumption or availability associated with an asset vault indicates geographical location where the energy is required or where the participant is located. It could indicate specific coordinates (latitude and longitude) for pinpointing energy demand at a precise location, or it could involve broader geographical boundaries such as cities, regions, or countries. The location of energy requirement or availability is governed by energy network providers' regulations. Governing by energy network providers' regulations indicate that the geographical distribution of energy supply and demand is influenced by rules, standards, and policies set by the entities responsible for managing energy networks, such as electric utilities and grid operators. These regulations shape how energy is delivered, transmitted, and consumed within a given area.

In an exemplary embodiment an asset vault may include physical batteries as an energy source. Physical batteries, such as those found in electric cars or home storage units, play a crucial role in serving as energy sources. These batteries act as reservoirs of stored electricity that can be tapped into when needed to supply power to the energy grid or to individual consumers. Electric vehicles (EVs) are equipped with high-capacity lithium-ion rechargeable batteries designed to power the vehicle's electric motor. When the vehicle is not in use, such as when it's parked at home or at a charging station, the battery can be connected to the energy grid to supply electricity or to extract energy from the grid. This stored energy can then be utilized by the battery to meet demand during peak periods or to provide backup power during outages.

Similarly, home storage units, also known as residential energy storage systems, consist of batteries installed within a household or building. These batteries can be charged using electricity from renewable sources, such as solar panels, or during off-peak hours when electricity prices are lower. The stored energy can be used to power the home's appliances and electronics or fed back into the grid when demand is high.

The energy stored in batteries, whether from electric cars or home storage units, can be utilized to both sell electricity and prevent the need for balancing power plants. Accordingly, the plurality of asset managers 204 can aggregate the energy stored in these home storage units to create a virtual power plant, which can help stabilize the grid and reduce reliance on traditional power plants.

In an embodiment, energy stored in batteries can be sold to the energy grid or directly to consumers during times of high demand when electricity prices are elevated. The plurality of asset managers 204 can instruct the plurality of asset vaults 202 to strategically discharge the stored energy from batteries when the market price for electricity is favorable, thereby maximizing revenue generation. By participating in energy markets, batteries can provide a valuable source of income for their owners while also contributing to grid stability and reliability.

In another exemplary embodiment, the disclosure can aid in preventing the need for balancing power plants that are traditionally used to adjust electricity supply to match fluctuating demand in real-time. By strategically deploying batteries, the plurality of asset managers 204 can mitigate the need for additional balancing power plants by providing rapid-response energy services. Batteries can respond almost instantaneously to fluctuations in demand or supply, injecting or absorbing electricity as needed to maintain grid stability. This rapid response capability helps prevent imbalances in the grid, reducing the reliance on conventional power plants that often have longer startup times and higher operating costs.

In an embodiment, the plurality of asset managers 204 are configured to manage energy consumption during brownouts or blackouts by leveraging virtual energy resources. The plurality of asset managers 204 continuously monitor grid conditions and anticipate potential brownouts or blackouts based on factors such as demand patterns, grid stability, and weather forecasts. Using advanced analytics and predictive algorithms, the plurality of asset managers 204 can identify areas at risk of experiencing power interruptions and proactively deploy strategies to manage energy consumption. The plurality of asset managers 204 can implement demand response programs that incentivize consumers to reduce their energy consumption during periods of grid stress. By communication with the plurality of asset vaults 202, the plurality of asset managers 204 can remotely adjust energy usage in real-time, temporarily reducing load to alleviate strain on the grid.

Consider an exemplary embodiment where in countries where hot climates often lead to high electricity demand for air conditioning, the plurality asset managers 204 can implement demand response programs to manage energy consumption during brownouts or blackouts. During periods of grid stress, the plurality of asset managers 204 can adjust the operation of the plurality of asset vaults 202 to command air conditioning units in residential and commercial buildings. By slightly increasing temperature setpoints or cycling off non-essential cooling systems, consumers can reduce their energy usage while still maintaining comfort levels.

Similarly, in countries where cold winters necessitate heavy reliance on heating systems, the plurality of asset managers 204 can leverage virtual energy to manage energy consumption during brownouts or blackouts. During grid emergencies, the plurality of asset managers 204 can remotely control the plurality of asset vaults 202 to control electric heating systems, such as electric boilers or heat pumps, to temporarily reduce energy demand. By slightly lowering indoor temperatures or adjusting heating schedules, consumers can conserve energy without compromising comfort.

In both the embodiments, this reduction in energy consumption effectively creates a virtual source of energy, referred to as virtual batteries, by preserving the available energy resources. The virtual batteries can then be utilized to support the grid during peak demand times or emergencies, providing a more reliable and efficient energy management system.

Therefore, in accordance with various embodiments, the plurality of asset vaults 202 are configured to include virtual batteries as the energy source. As explained earlier, virtual energy from virtual batteries refers to the potential energy savings that can be realized by adjusting the operation of controllable devices, such as HVAC (heating, ventilation, and air conditioning) systems, based on real-time grid conditions or predetermined criteria. Rather than storing electricity in physical batteries, virtual energy represents the ability to temporarily reduce energy consumption or shift it to off-peak periods through automated control systems.

Each asset manager 204-1, 204-2, 204-N−1 . . . 204-N of the plurality of asset managers 204 analyzes information received from a corresponding asset vault of the plurality of asset vaults 202 to create a profile for an associated participant with consumption and production proposals along with the plurality of parameters indicating time or energy consumption or availability, energy-type consumption or availability, and location of energy consumption or availability. By representing the plurality of participants 104 in the energy control platform 108, each asset manager can actively engage in trading activities, leveraging the detailed profiles to make informed decisions.

In an embodiment, the plurality of asset managers 204 are connected to one another via an overlay communication network, establishing a robust and dynamic framework for communication and collaboration among the asset managers 204. The overlay network enables seamless communication and data exchange between the plurality of asset managers 204 regardless of their physical locations or the specific technologies they employ. In an embodiment, the asset managers may share user profiles with each other.

Each control unit 208-1, 208-2, 208-N−1 . . . 208-N of the plurality of control units 208 are connected to the plurality of asset managers 204 via one or more communication interfaces 206. The one or more communication interface(s) 206 may include one or more interfaces to enable the energy control platform 108 to access a computer network such as a Location Area Network (LAN), a Wide Area Network (WAN), a Personal Area Network (PAN), or the internet through a variety of wired and/or wireless connections, including cellular connections. In an embodiment, a control unit communicates with a subset of asset managers of the plurality of asset managers 204.

Each control unit 208-1, 208-2, 208-N−1 . . . 208-N of the plurality of control units 208 is configured to analyze the plurality of parameters and profiles for associated participants received from one or more asset managers (the subset of asset managers) of the plurality of asset managers 204. Thereafter, each control unit 208-1, 208-2, 208-N−1 . . . 208-N categorizes one or more asset managers into a plurality of asset manager pools based on the plurality of parameters. Accordingly, each control 208-1, 208-2, 208-N−1 . . . 208-N unit may manage one or more asset manager pools.

In an embodiment, the plurality of control units 208 employ one or more clustering algorithms to categorize the plurality of asset managers 204 into the plurality of asset manager pools based on the plurality of parameters associated with each asset manager.

In an embodiment, the plurality of control units 208 select one or more clustering algorithms suitable for the task at hand, considering factors such as the nature of the data, the desired number of clusters, and computational efficiency. Common clustering algorithms used in this context include K-means, hierarchical clustering, DBSCAN, and Gaussian mixture models.

The selected clustering algorithms are applied to the plurality of parameters to categorize the plurality of asset managers 204 into the plurality of asset manager pools. The algorithm iteratively assigns asset managers to clusters, aiming to minimize within-cluster variance and maximize between-cluster differences. This process continues until convergence is reached, and each asset manager is assigned to one or more clusters.

Moving on, each control unit computes an aggregate production and consumption proposal corresponding to each asset manager pool controlled by the control unit is managing. This aggregation is based on the individual consumption and production proposals for each asset manager within the asset manager pool. For instance, computation of aggregate production and consumption may involve data aggregation, analysis and forecasting of production and consumption patterns, optimization of production and consumption proposals, and proposal generation with a detailed aggregate production and consumption proposal for each asset manager pool. This approach ensures that the aggregated proposals accurately reflect the collective capabilities and needs of the individual asset managers, leading to more effective and efficient energy management strategies.

In accordance with the embodiment, each control unit of the plurality of control units 208 computes one or more bids for each asset manager pool, managed by the control unit, for the corresponding aggregate production and consumption proposal.

In an embodiment, the one or more bids are computed by considering parameters such as, current supply and demand conditions, energy market prices, historical consumption patterns, and any constraints or preferences specified by asset manager pools. The computed bids specify the quantity of energy to be bought or sold, the price at which the transaction is proposed, and any additional terms or conditions relevant to the transaction.

In accordance with the embodiment, the plurality of control units 208 are configured to integrate with external data sources for computing energy demand-supply predictions and pricing recommendations. This integration allows the plurality of control units 208 to access a wide range of relevant data sources, such as, but not limited to, weather data, energy grid data, market data, historical data, economic indicators, demand response signals, regulatory updates.

Upon computing the one or more bids, the plurality of control units 208 share them with the corresponding asset manager pools for review and approval. The asset manager pools may have the option to accept, reject, or negotiate the proposed bids based on their specific goals, constraints, and market conditions. Once the bids are finalized, the plurality of control units 208 submit the one or bids to the exchange unit 210.

The exchange unit 210 receives the one or more bids from the plurality of control units 208, via the one or more communication interface(s) 206. The exchange unit 210 comprises logic, interfaces, and/or code is configured to identify one or more other asset manager pools matching the aggregate production and consumption proposal of a given asset manager pool based on the plurality of parameters. During matching, the exchange unit 210 assesses the degree of match between different proposals. This could include metrics such as the similarity of production and consumption patterns, alignment of resource requirements, and compatibility of operational objectives.

The exchange unit 210 may utilize one or more matching algorithms to identify the matching between aggregate production and consumption proposals. The matching algorithms use a set or parameters to analyze and compare the characteristics of asset manager pools and proposals, aiming to find the most suitable matches.

Upon identifying probable matches, the exchange unit 210 places bids (as received from the plurality of control units 208 on behalf of a given asset manager pool to the one or more other asset manager pools. During the process, the exchange unit 210 places bids for the aggregate production and consumption proposals corresponding to the identified asset manager pools. These bids outline the terms, conditions, and commitments for collaboration, including production targets, resource contributions, scheduling considerations, and any other relevant details.

In an embodiment, the exchange unit 210 processes market data and historical records to identify patterns and predict future market movements. Based on its analysis, the exchange unit 210 may offers pricing recommendations, during negotiation, to the plurality of control units 208 and/or the plurality of asset managers 204, suggesting pricing strategies that align with market conditions and objectives. It also facilitates matching bids with suitable opportunities, ensuring bids are paired with compatible pricing and market conditions. The exchange unit 210 continually monitors market changes and adjusts recommendations in real-time to keep bids competitive and aligned with market trends.

Upon acceptance of the bids by the one or more other asset manager pools, the exchange unit 210 completes one or more transactions. These transactions involve the exchange of resources, commitments, and contractual agreements between the participating parties.

In an embodiment, the disclosure employs smart contracts to complete the one or more transactions. The smart contracts encode the terms and conditions of the transactions agreed upon by the participating parties. These smart contracts are programmed to automatically execute predefined actions once specified conditions are met. In an embodiment, the exchange unit 210 defines the parameters of the transactions, including the assets involved, pricing terms, delivery schedules, and any other relevant terms and conditions. These parameters are encoded into the smart contracts to govern the transaction process.

In an embodiment, smart contracts are deployed on a Blockchain platform. In other embodiments, the smart contracts can be deployed on various other platforms, including SQL databases, or other data processing and storage technologies, depending on the specific requirements and objectives of the transactional system. SQL databases offer robust data processing and storage capabilities.

Upon the completion of a transaction, the exchange unit 210 automatically generates a contract between the matched asset manager pools. This contract formalizes the terms and conditions of the transaction, outlining the rights, obligations, and responsibilities of each asset manager pool involved.

In an embodiment, the exchange unit 210, while completing the one or more transactions, facilitates micro-transactions of energy assets between participants of the matched asset manager pools. These micro-transactions involve the exchange of small units of energy assets among the matched asset vaults through the energy grids.

This technical advancement enables small players, who may not have the capacity to trade large volumes of energy, to actively participate in the energy trading market. Unlike traditional systems that often favor larger entities due to their capacity for high-volume transactions, this disclosure democratizes energy trading by accommodating smaller transactions. This inclusivity promotes broader market participation, enhances market liquidity, and allows for a more efficient and flexible energy grid. By supporting micro-transactions, the disclosure ensures that all participants, regardless of size, can contribute to and benefit from the energy trading ecosystem, thus fostering a more resilient and dynamic energy market.

In an embodiment, if the exchange unit 210 determines that there are leftover bids that were not successfully matched among the plurality of asset manager pools during the initial round of bid processing, it collaborates with the exchanges of the energy grids 102 to attempt to fulfill these unmatched requirements.

The exchange unit 210 engages in real-time communication with the exchanges of the energy grids 102 to gather data on current supply and demand dynamics, available energy resources, and any operational constraints or preferences that may impact bid matching. This communication may utilize standardized data exchange protocols and APIs to ensure seamless interoperability and data accuracy.

Based on the information obtained from the energy grid exchanges, the exchange unit 210 employs advanced algorithms to generate revised bids. These revised bids take into account the residual demand or supply requirements, optimizing parameters such as quantity, price, and timing information to enhance the likelihood of successful matches. The revised bids are then resubmitted to the energy grid exchanges for further processing and potential matching.

Additionally, the exchange unit 210 may employ predictive analytics and machine learning techniques to anticipate future market conditions and adjust the revised bids accordingly. This proactive approach ensures that the bids remain competitive and aligned with evolving market trends, thereby increasing the probability of successful transactions.

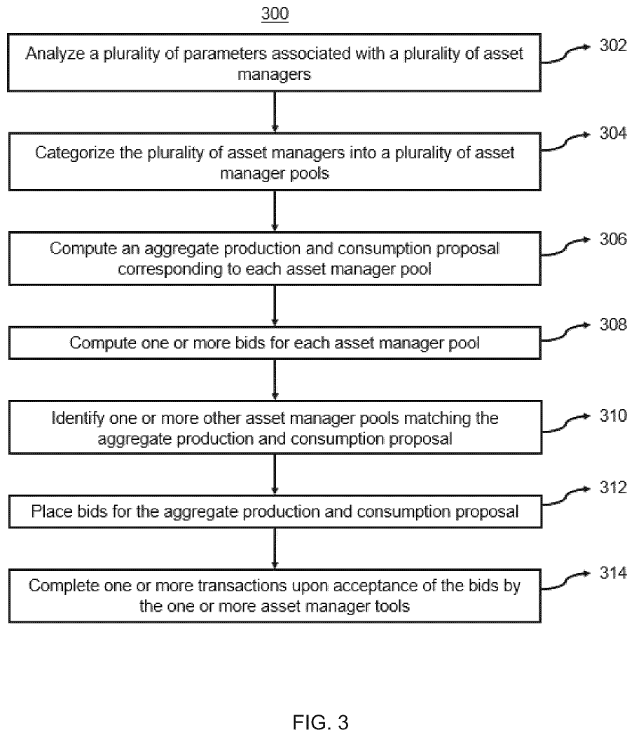

FIG. 3 is a diagram that illustrates a flow chart for a method 300 for enabling P2P transactions of energy assets among a plurality of participants 104 of an energy control platform 108, in accordance with an embodiment of the disclosure.

At 302, the plurality of control units 208 analyze the plurality of parameters associated with the plurality of asset managers 204, wherein the plurality of parameters comprises timing information, energy-type and location of energy requirement or availability.

At 304, the plurality of control units 208 categorize the plurality of asset managers 204 into a plurality of asset manager pools based on the plurality of parameters.

The plurality of control units 208 employ one or more clustering algorithms to categorize the plurality of asset managers 204 into the plurality of asset manager pools based on the plurality of parameters associated with each asset manager.

At 306, the plurality of control units 208 compute an aggregate production and consumption proposal corresponding to each asset manager pool of the plurality of asset manager pools. This aggregation is based on the individual consumption and production proposals for each asset manager within the pool. For instance, computation of aggregate production and consumption may involve data aggregation, analysis and forecasting of production and consumption patterns, optimization of production and consumption proposals, and proposal generation with a detailed aggregate production and consumption proposal for each asset manager pool. This approach ensures that the aggregated proposals accurately reflect the collective capabilities and needs of the individual asset managers, leading to more effective and efficient energy management strategies.

At 308, the plurality of control units 208 computes one or more bids for each asset manager pool for the corresponding aggregate production and consumption proposal. In an embodiment, the plurality of control units 208 compute the one or more bids by considering parameters such as, current supply and demand conditions, energy market prices, historical consumption patterns, and any constraints or preferences specified by asset manager pools. The computed bids specify the quantity of energy to be bought or sold, the price at which the transaction is proposed, and any additional terms or conditions relevant to the transaction.

Utilizing advanced forecasting techniques, the plurality of control units 208 predicts future energy demand based on historical data, weather patterns, economic indicators, and other relevant factors. This helps in estimating the amount of energy that needs to be produced or procured to meet the anticipated demand.

Once the one or more bids are computed, the plurality of control unit 208 share them with the corresponding asset manager pools for review and approval. The asset manager pools may have the option to accept, reject, or negotiate the proposed bids based on their specific goals, constraints, and market conditions. Once the bids are finalized, the plurality of control units 208 submit the one or bids to the exchange unit 210.

At 310, the exchange unit 210 identifies one or more other asset manager pools matching an aggregate production and consumption proposal of a given asset manager pool based on the plurality of parameters.

At 312, the exchange unit 210 places bids for the aggregate production and consumption proposal corresponding to the one or more other asset manager pools identified as potential match. These bids outline the terms, conditions, and commitments for collaboration, including production targets, resource contributions, scheduling considerations, and any other relevant details.

In an embodiment, the exchange unit 210 processes market data and historical records to identify patterns and predict future market movements. Based on its analysis, the exchange unit 210 may offer pricing recommendations, during negotiation, to asset manager pools, suggesting pricing strategies that align with market conditions and objectives. It also facilitates matching bids with suitable opportunities, ensuring bids are paired with compatible pricing and market conditions. The exchange unit 210 continually monitors market changes and adjusts recommendations in real-time to keep bids competitive and aligned with market trends.

At 314, one or more transactions are completed upon acceptance of the one or more bids by the one or more asset manager pools. In an embodiment, the disclosure employs smart contracts to complete the one or more transactions. The smart contracts encode the terms and conditions of the transactions agreed upon by the participating parties. These smart contracts are programmed to automatically execute predefined actions once specified conditions are met. In an embodiment, the exchange unit 210 defines the parameters of the transactions, including the assets involved, pricing terms, delivery schedules, and any other relevant terms and conditions. These parameters are encoded into the smart contracts to govern the transaction process.

Upon the completion of a transaction, the exchange unit 210 automatically generates a contract between the matched asset manager pools. This contract formalizes the terms and conditions of the transaction, outlining the rights, obligations, and responsibilities of each asset manager pool involved.

In an embodiment, the exchange unit 210, while completing the one or more transactions, facilitates micro-transactions of energy assets between participants of the matched asset manager pools. These micro-transactions involve the exchange of small units of energy assets among the matched asset vaults through the energy grids.

In an embodiment, if the exchange unit 210 determines that there are leftover bids that were not successfully matched among the plurality of asset manager pools during the initial round of bid processing, it collaborates with the exchanges of the energy grids 102 to attempt to fulfill these unmatched requirements.

The exchange unit 210 engages in real-time communication with the exchanges of the energy grids 102 to gather data on current supply and demand dynamics, available energy resources, and any operational constraints or preferences that may impact bid matching. This communication may utilize standardized data exchange protocols and APIs to ensure seamless interoperability and data accuracy.

Based on the information obtained from the energy grid exchanges, the exchange unit 210 employs advanced algorithms to generate revised bids. These revised bids take into account the residual demand or supply requirements, optimizing parameters such as quantity, price, and timing information to enhance the likelihood of successful matches. The revised bids are then resubmitted to the energy grid exchanges for further processing and potential matching.

Additionally, the exchange unit 210 may employ predictive analytics and machine learning techniques to anticipate future market conditions and adjust the revised bids accordingly. This proactive approach ensures that the bids remain competitive and aligned with evolving market trends, thereby increasing the probability of successful transactions.

The present disclosure addresses the critical need for a fast, time-sensitive system to match supply and demand during abnormal situations by enabling rapid energy cuts (acting as a virtual battery) or drawing from actual batteries. The disclosure offers a method to manage and reduce kWh consumption when brownouts or blackouts are imminent. Additionally, it provides a mechanism to mitigate kWh price hikes during abnormal conditions, such as extreme weather or unexpected shortages of wind and hydro energy. This capability ensures a more stable and predictable energy market, even under stress, by dynamically balancing supply and demand in real-time.

The present disclosure offers a significant advancement by enabling small players to actively participate in the energy trading market. Current electricity trading systems are too rigid and expensive, catering primarily to large transactions and excluding smaller participants due to high costs and complicated contractual requirements. This is achieved through the creation of user pools based on multiple parameters, facilitating transactions among these pools. Once transactions are executed within a pool, the system enables micro-transactions between the small players within these pools. This granularity ensures that even the smallest energy producers and consumers can engage in the marketplace, democratizing access and fostering inclusivity. By supporting micro-transactions, the system ensures that small players can contribute to and benefit from the energy trading ecosystem, promoting a more resilient and dynamic market.

Another key advantage of the present disclosure is the use of advanced clustering mechanisms to create user pools based on the profiles of participants. These profiles consider various factors including the type of energy, whether the requirement is real-time or for future use, and the geographical location of the user. Such granularity in forming user pools ensures efficient trading of energy assets by grouping participants with similar needs and characteristics. This targeted approach optimizes energy transactions, reduces inefficiencies, and ensures better alignment with market demands, ultimately leading to a more efficient and flexible energy grid.

The present disclosure also leverages sophisticated machine learning models and predictive analytics to further enhance energy trading. These models analyze historical data, market trends, and real-time information to forecast energy demand and supply dynamics with high accuracy. By intelligently allocating resources and optimizing trading strategies, the system maximizes energy utilization while minimizing waste. The machine learning algorithms also identify profitable trading opportunities and mitigate risks, ensuring that transactions are conducted efficiently and effectively. This technological enhancement ensures that small players can contribute to and benefit from the energy trading ecosystem, supporting a more inclusive and efficient market.

Those skilled in the art will realize that the above-recognized advantages and other advantages described herein are merely exemplary and are not meant to be a complete rendering of all of the advantages of the various embodiments of the present disclosure.

In the foregoing complete specification, specific embodiments of the present disclosure have been described. However, one of ordinary skill in the art appreciates that various modifications and changes can be made without departing from the scope of the present disclosure. Accordingly, the specification and figures are to be regarded in an illustrative rather than a restrictive sense. All such modifications are intended to be included within the scope of the present disclosure.

What is claimed is:

1. An energy control platform enabling peer-to-peer (P2P) sharing of energy assets among a plurality of participants of the energy control platform, the energy control platform comprising:
a plurality of asset vaults connected to an energy grid, wherein each participant of the plurality of participants is associated with a corresponding asset vault configured to consume energy, produce energy, and store energy;
a plurality of asset managers connected via an overlay communication network, wherein an asset vault is managed by a dedicated asset manager of the plurality of asset managers;
a plurality of control units, wherein a control unit of the plurality of control units is configured to:
analyze a plurality of parameters associated with the plurality of asset managers, wherein the plurality of parameters comprises timing information, energy-type and location of energy requirement or availability;
categorize the plurality of asset managers into a plurality of asset manager pools based on the plurality of parameters;
compute an aggregate production and consumption proposal corresponding to each asset manager pool of the plurality of asset manager pools;
compute one or more bids for each asset manager pool for the corresponding aggregate production and consumption proposal;
an exchange unit, where in the exchange unit is configured to:
receive the one or more bids corresponding to the plurality of asset manager pools from the plurality of control units;
identify one or more other asset manager pools to match the aggregate production and consumption proposal of an asset manager pool based on the plurality of parameters;
place bids for the aggregate production and consumption proposal corresponding to the one or more other asset manager pools; and
complete one or more transactions upon acceptance of the bids by the one or more asset manager pools.

2. The energy control platform of claim 1, wherein an asset manager of the plurality of asset managers is configured to dynamically regulate at least one of energy consumption or energy production of a corresponding asset vault.

3. The energy control platform of claim 2, wherein the asset manager is further configured to create a virtual battery based on the dynamic regulation of the at least one of the energy consumption or the production of the corresponding asset vault, wherein the virtual battery is a logical collection of physical storage, production and consumption devices.

4. The energy control platform of claim 3, wherein the asset manager of the plurality of asset managers is configured to control the corresponding asset vault to delay the at least one of the energy consumption or the production at a specific time to balance energy usage of a corresponding energy grid to which the corresponding asset vault is connected.

5. The energy control platform of claim 2, wherein the plurality of asset managers is configured to delay the energy consumption or production of their corresponding asset vaults at specific parts of the energy grid to facilitate transfer of energy to other grid localities.

6. The energy control platform of claim 1, wherein the control unit is further configured to employ a clustering algorithm, to categorize the plurality of asset managers into the plurality of asset manager pools, based on energy information and the plurality of parameters associated with each asset manager of the plurality of asset managers, wherein energy information corresponding to each asset manager of the plurality of asset managers comprises one of a consumption requirement or a production offer of a participant of the plurality of participants.

7. The energy control platform of claim 1, wherein the timing information of energy requirement or availability comprises real-time consumption requirements and production offers, and future consumption requirements and production offers.

8. The energy control platform of claim 1, wherein the energy-type of energy requirement or availability comprises a wind-based energy production, a solar-based energy production, hydro-based energy production, nuclear based energy production, and a coal-based energy production.

9. The energy control platform of claim 1, wherein the location of energy requirement or availability is governed by energy network providers' regulations.

10. The energy control platform of claim 1, wherein the completion of the one or more transactions is facilitated through smart contracts.

11. The energy control platform of claim 10, wherein the smart contracts are deployed on a blockchain network, on SQL database, or other data processing and storage technologies.

12. The energy control platform of claim 10 further comprising generating an automatic contract between the matched asset manager pools upon completion of a transaction.

13. The energy control platform of claim 1, wherein the exchange unit is further configured to facilitate micro-transactions of energy assets between participants of the matched asset manager pools.

14. The energy control platform of claim 13, wherein the exchange unit is further configured to transfer the corresponding energy assets between the corresponding asset vaults of the asset managers of the matched asset manager pools using corresponding energy grids.

15. A method for enabling peer-to-peer (P2P) sharing of energy assets among a plurality of participants of the energy control platform, wherein each participant is associated with a corresponding asset vault of a plurality of asset vaults connected to an energy grid, and each asset vault is managed by a corresponding asset manager of a plurality of asset managers, the method comprising:
analyzing, by a plurality of control units, a plurality of parameters associated with the plurality of asset managers, wherein the plurality of parameters comprises timing information, energy-type and location of energy requirement or availability;
categorizing, by the plurality of control units, the plurality of asset managers into a plurality of asset manager pools based on the plurality of parameters;
computing, by the plurality of control units, an aggregate production and consumption proposal corresponding to each asset manager pool of the plurality of asset manager pools;
computing, by the plurality of control units, one or more bids for each asset manager pool for the corresponding aggregate production and consumption proposal;
receiving, by an exchange unit, the one or more bids corresponding to the plurality of asset manager pools from the plurality of control units;
identifying, by the exchange unit, one or more other asset manager pools matching the aggregate production and consumption proposal of an asset manager pool based on the plurality of parameters;
placing, by the exchange unit, bids for the aggregate production and consumption proposal corresponding to the one or more other asset manager pools; and
completing, by the exchange unit, one or more transactions upon acceptance of the bids by the one or more asset manager pools.

16. The method of claim 15, wherein an asset manager of the plurality of asset managers is configured to dynamically regulate energy consumption and/or energy production of a corresponding asset vault.

17. The method of claim 15, wherein the asset manager is further configured to create a virtual battery in response to dynamically regulating energy consumption and production of the corresponding asset vault, wherein the virtual battery is a logical collection of physical storage, production and consumption devices.

18. The method of claim 17, wherein the asset manager of the plurality of asset managers is configured to control the corresponding asset vault to delay the energy consumption or production at specific time to balance energy usage of a corresponding energy grid to which the corresponding asset vault is connected.

19. The method of claim 15, wherein the plurality of asset managers are configured to delay the energy consumption or production of their corresponding asset vaults at specific parts of the energy grid thereby facilitating transfer of energy to other grid localities.

20. The method of claim 15, wherein the placing bids comprises calculating a pricing recommendation or matching for bids placed on behalf of asset manager pools or asset managers, based on market conditions and historical transaction data.

21. The method of claim 15 wherein completion of the one or more transactions are facilitated through smart contracts.

22. The method of claim 15, wherein the completion of the one or more transactions comprises generating an automatic contract between the matched asset manager pools upon completion of a transaction.

23. The method of claim 15, wherein the completion of the one or more transactions further comprises facilitating micro-transactions of energy assets between participants of the matched asset manager pools, wherein the micro-transactions include transferring the corresponding energy assets between the matched asset managers using the energy grid.
